(19) United States
(12) Patent Application Publication
(10) Pub. No.: US 2012/0154953 A1
(43) Pub. Date: Jun. 21, 2012

(54) HEAD WITH ALTITUDE RESISTANT AIR-BEARING SURFACE

(76) Inventors: Lee Dorius, San Jose, CA (US); Weidong Huang, Palo Alto, CA (US)

(21) Appl. No.: 12/972,201

(22) Filed: Dec. 17, 2010

(51) Int. Cl. G11B 17/32

(52) U.S. Cl. 360/235.4; G9B/17.061

(57) ABSTRACT

Approaches for a head slider for use within a hard-disk drive. The head slider comprises an air bearing surface (ABS) and an electromagnetic transducer disposed at an air outflow end of the air bearing surface. The air bearing surface comprises a slit feature that is present prior to the electromagnetic transducer in the direction of air flow. The physical dimensions of the slit feature are designed to lower an amount of pressure required for a protrusion of the head slider to detect a surface of a magnetic-recording disk. The air bearing surface may further comprise an optional hollow recess prior to the slit feature in the direction of air flow. The size and the shape of the hollow recess are designed to decrease a change in a fly height of the head slider in response to a change in altitude of the hard-disk drive.

### FIELD OF THE INVENTION

Embodiments of the invention generally relate to the air-bearing surface (ABS) of a read/write head of a hard-disk drive (HDD).

### BACKGROUND OF THE INVENTION

A hard-disk drive (HDD) is a non-volatile storage device that is housed in a protective enclosure and stores digitally encoded data on one or more circular disks having magnetic surfaces (a disk may also be referred to as a platter). When an HDD is in operation, each magnetic-recording disk is rapidly rotated by a spindle system. Data is read from and written to a magnetic-recording disk using a read/write head which is positioned over a specific location of a disk by an actuator.

A read/write head uses a magnetic field to read data from and write data to the surface of a magnetic-recording disk. As a magnetic dipole field decreases rapidly with distance from a magnetic pole, the distance between a read/write head and the surface of a magnetic-recording disk must be tightly controlled. An actuator relies on suspension's force on the read/write head to provide the proper distance between the read/write head and the surface of the magnetic-recording disk while the magnetic-recording disk rotates. A read/write head therefore is said to “fly” over the surface of the magnetic-recording disk. When the magnetic-recording disk stops spinning, a read/write head must either “land” or be pulled away onto a mechanical landing ramp from the disk surface.

It is desirable, for a variety of reasons, to maintain a constant or approximately constant distance between the read/write head and the surface of the magnetic-recording disk to ensure proper operation of the read/write head. If the distance between a read/write head and the surface of a magnetic-recording disk fluctuates, then the strength of the magnetic dipole field between the read/write head and the surface of the magnetic-recording disk will also fluctuate, which may cause problems in reading data from or writing data to the magnetic-recording disk.

### SUMMARY OF THE INVENTION

It is observed that when a hard-disk drive (HDD) changes elevation, the fly height of the head slider may change. For example, when a hard-disk drive is taken from sea level to a high altitude, the fly height of the head slider tends to decrease. If the distance between a read/write head and the surface of a magnetic-recording disk fluctuates, then the strength of the magnetic dipole field between the read/write head and the surface of the magnetic-recording disk will also fluctuate, which may cause problems in reading data from or writing data to the magnetic-recording disk. Therefore, a head slider that is resistant to altitude changes would be desirable. By “resistant to altitude changes,” that is to say, that the fly height of a head slider does not change much in response to a change in altitude as in prior approaches.

In an embodiment, a hard-disk drive includes a head slider that comprises an air bearing surface (ABS). The air bearing surface has, disposed thereon at an air outflow end of the air bearing surface, an electromagnetic transducer. The air bearing surface further comprises a slit feature that is positioned before the electromagnetic transducer in the direction of air flow across the air bearing surface. The physical dimensions of the slit feature are designed to lower an amount of pressure required for a protrusion of the head slider to detect a surface of a magnetic-recording disk.

The air bearing surface may further comprise an optional hollow cavity positioned before the slit feature in the direction of air flow. The size and the shape of the hollow cavity are designed to decrease a change in a fly height of the head slider in response to a change in altitude of the hard-disk drive. Certain embodiments may employ a slit feature in conjunction with the hollow cavity so that certain disadvantages of employing the hollow cavity are mitigated or overcome through use of the slit feature, while still yielding the advantages of using the hollow cavity.

Embodiments discussed in the Summary of the Invention section are not meant to suggest, describe, or teach all the embodiments discussed herein. Thus, embodiments of the invention may contain additional or different features than those discussed in this section.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a plan view of an HDD according to an embodiment of the invention;

FIG. 2 is plan view of a head-arm-assembly (HAA) according to an embodiment of the invention;

FIG. 3 is an illustration of an air bearing surface of a read/write head according to an embodiment of the invention; and

FIG. 4 is a table illustrating exemplary characteristics of the air bearing surface of a head according to an embodiment of the invention.

### DETAILED DESCRIPTION OF THE INVENTION

Approaches for an air bearing surface of a read/write head which is more resistant to changes in altitude are presented herein. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form in order to avoid unnecessarily obscuring the embodiments of the invention described herein.

### Physical Description of Illustrative Hard-Disk Drives

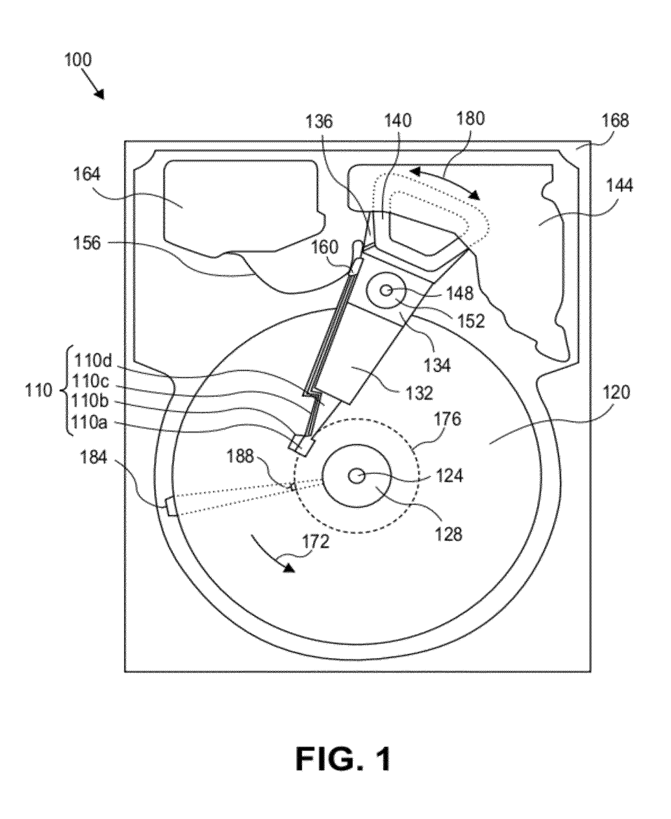

Prior to describing the air bearing surface (ABS) of a read/write head according to an embodiment, it may be helpful to understand the context in which the ABS of the read/write head will be employed. With reference to FIG. 1, a plan view of a HDD 100 is shown. FIG. 1 illustrates the functional arrangement of components of the HDD including a slider 110b including a magnetic-recording head 110a. The HDD 100 includes at least one HGA 110 including the head 110a, a lead suspension 110c attached to the head 110a, and a load beam 110d attached to the slider 110b, which includes the head 110a at a distal end of the slider 110b; the slider 110b is attached at the distal end of the load beam 110d to a gimbal portion of the load beam 110d. The HDD 100 also includes at least one magnetic-recording disk 120 rotatably mounted on a spindle 124 and a drive motor (not shown) attached to the spindle 124 for rotating the disk 120. The head 110a includes a write element, a so-called writer, and a read element, a so-called reader, for respectively writing and reading information stored on the disk 120 of the HDD 100. The disk 120 or a plurality (not shown) of disks may be affixed to the spindle 124 with a disk clamp 128. The HDD 100 further includes an arm 132 attached to the HGA 110, a carriage 134, a voice-coil motor (VCM) that includes an armature 136 including a voice coil 140 attached to the carriage 134; and a stator 144 including a voice-coil magnet (not shown); the armature 136 of the VCM is attached to the carriage 134 and is configured to move the arm 132 and the HGA 110 to access portions of the disk 120 being mounted on a pivot-shaft 148 with an interposed pivot-bearing assembly 152.

With further reference to FIG. 1, electrical signals, for example, current to the voice coil 140 of the VCM, write signal to and read signal from the PMR head 110a, are provided by a flexible cable 156. Interconnection between the flexible cable 156 and the head 110a may be provided by an arm-electronics (AE) module 160, which may have an on-board pre-amplifier for the read signal, as well as other read-channel and write-channel electronic components. The flexible cable 156 is coupled to an electrical-connector block 164, which provides electrical communication through electrical feedthroughs (not shown) provided by an HDD housing 168. The HDD housing 168, also referred to as a casting, depending upon whether the HDD housing is cast, in conjunction with an HDD cover (not shown) provides a sealed, protective enclosure for the information storage components of the HDD 100.

With further reference to FIG. 1, other electronic components (not shown), including a disk controller and servo electronics including a digital-signal processor (DSP), provide electrical signals to the drive motor, the voice coil 140 of the VCM and the head 110a of the HGA 110. The electrical signal provided to the drive motor enables the drive motor to spin providing a torque to the spindle 124 which is in turn transmitted to the disk 120 that is affixed to the spindle 124 by the disk clamp 128; as a result, the disk 120 spins in a direction 172. The spinning disk 120 creates a cushion of air that acts as an air-bearing on which the air-bearing surface (ABS) of the slider 110b rides so that the slider 110b flies above the surface of the disk 120 without making contact with a thin magnetic-recording medium of the disk 120 in which information is recorded. The electrical signal provided to the voice coil 140 of the VCM enables the head 110a of the HGA 110 to access a track 176 on which information is recorded. Thus, the armature 136 of the VCM swings through an arc 180 which enables the HGA 110 attached to the armature 136 by the arm 132 to access various tracks on the disk 120. Information is stored on the disk 120 in a plurality of concentric tracks (not shown) arranged in sectors on the disk 120, for example, sector 184. Correspondingly, each track is composed of a plurality of sectored track portions, for example, sectored track portion 188. Each sectored track portion 188 is composed of recorded data and a header containing a servo-burst-signal pattern, for example, an ABCD-servo-burst-signal pattern, information that identifies the track 176, and error correction code information. In accessing the track 176, the read element of the head 110a of the HGA 110 reads the servo-burst-signal pattern which provides a position-error-signal (PES) to the servo electronics, which controls the electrical signal provided to the voice coil 140 of the VCM, enabling the head 110a to follow the track 176. Upon finding the track 176 and identifying a particular sectored track portion 188, the head 110a either reads data from the track 176 or writes data to the track 176 depending on instructions received by the disk controller from an external agent, for example, a microprocessor of a computer system.

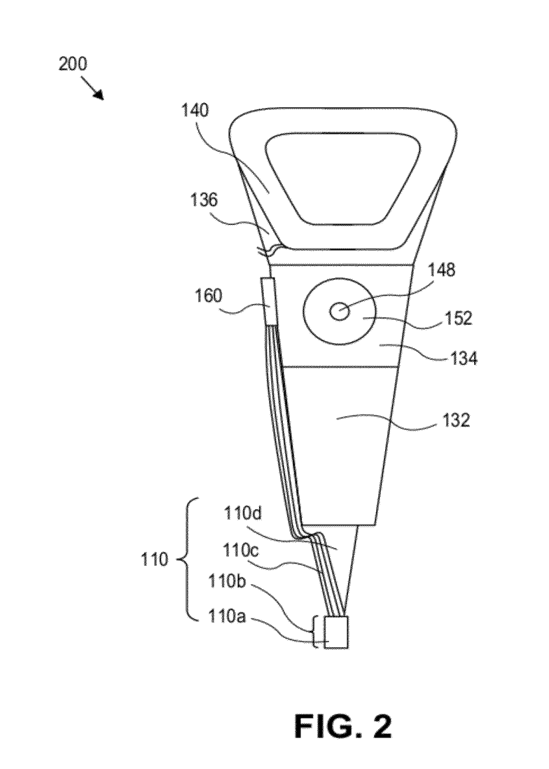

With reference now to FIG. 2, a plan view of a head-arm-assembly (HAA) including the HGA 110 is shown. FIG. 2 illustrates the functional arrangement of the HAA with respect to the HGA 110. The HAA includes the arm 132 and HGA 110 including the slider 110b including the head 110a. The HAA is attached at the arm 132 to the carriage 134. In the case of an HDD having multiple disks, or platters as disks are sometimes referred to in the art, the carriage 134 is called an “E-block,” or comb, because the carriage is arranged to carry a ganged array of arms that gives it the appearance of a comb. As shown in FIG. 2, the armature 136 of the VCM is attached to the carriage 134 and the voice coil 140 is attached to the armature 136. The AE 160 may be attached to the carriage 134 as shown. The carriage 134 is mounted on the pivot-shaft 148 with the interposed pivot-bearing assembly 152.

### An Altitude Resistent Air Bearing Surface

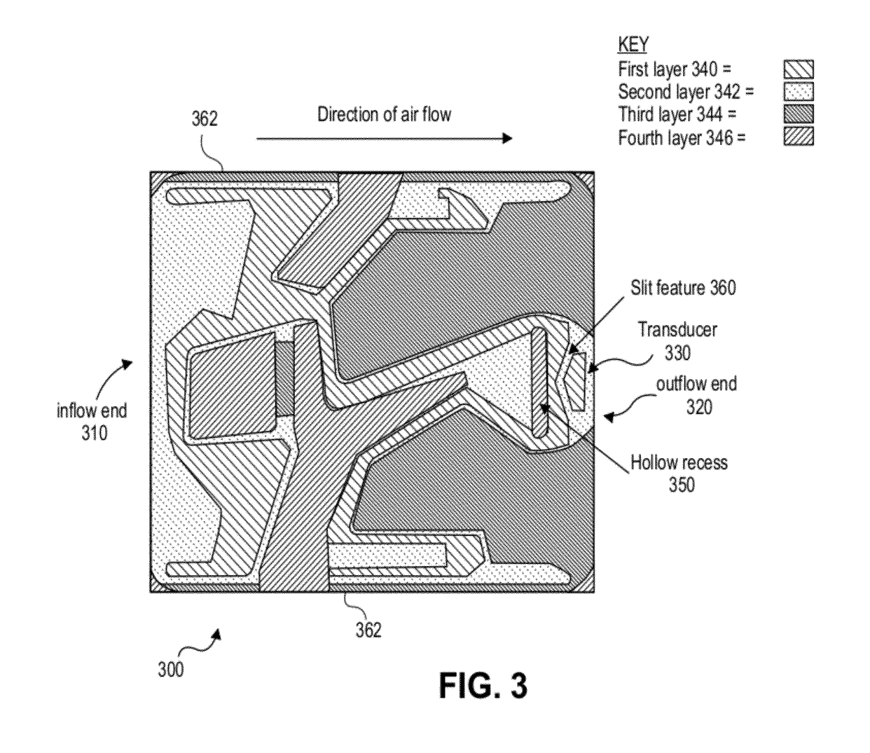

FIG. 3 is an illustration of an air bearing surface 300 of a read/write head according to an embodiment of the invention. Air bearing surface 300 (hereafter ABS 300) possesses an inflow end 310 and an outflow end 320. As shown in FIG. 3, air flows over ABS 300 in the direction of inflow end 310 to outflow end 320.

ABS 300 comprises a transducer 330 in the central portion of outflow end 320. Transducer 330 is a component which converts electrical current into a magnetic field and vice-versa. Transducer 330 is used to read data from and write data to the electromagnetic surface of the disk.

ABS 300 comprises a plurality of features which promote the successful operation of transducer 330. These features may be created by etching into the plurality of layers forming ABS 300. The process of etching to remove portions of the layers of an air bearing surface of a read/write head to create features on the air bearing surface is well known to those in the art.

As shown in FIG. 3, ABS 300 is formed by etching the three outermost layers forming ABS 300. First layer 340 is the outermost layer of ABS 300. Underneath first layer 340 is second layer 342. Underneath second layer 342 is third layer 344. Underneath third layer 344 is fourth layer 346. Thus, fourth layer 346 is deeper than third layer 344, third layer 344 is deeper than second layer 342, and so on.

ABS 300 comprises a hollow recess 350. Hollow recess 350 may be formed by etching a hole or hollow cavity through layers 340, 342, and 344 to expose layer 346. Thus, layer 346 forms the bottom of hollow recess 350 in an embodiment. In an embodiment, hollow recess 350 is positioned equidistant from side 360 and side 362. Hollow recess 350 may also be positioned before transducer 330 in the direction of air flow over ABS 300 as depicted in FIG. 3. Hollow recess 350 may run substantially perpendicular to the direction of air flow across ABS 300.

The use of hollow recess 350 yields the advantage of rendering ABS 300 resistant to changes in altitude. More specifically, the inclusion of hollow recess 350 in ABS 300 results in a smaller reduction in fly height of the read/write head when an increase in altitude is experienced. Hollow recess 350 provides a zone of air in the recess cavity that is less sensitive to changes in the ambient pressure caused by altitude. This results in higher air pressure downstream that increases the touchdown pressure when the extendable protrusion approaches the disk.

In different embodiments, the size and the shape of hollow recess 350 may differ, as long as the dimensions of hollow recess 350 achieve the objective of decreasing a change in a fly height of the head slider in response to a change in altitude of the hard-disk drive. In one particular embodiment, hollow recess 350 has an etch depth between 1.0 microns and 1.37 microns.

However, use of hollow recess 350 has a drawback in that such use also tends to increases touchdown pressure. Touchdown pressure is the pressure asserted against a protrusion of the read/write head that is used to determine the fly height of ABS 300 during a calibration process. An extendable protrusion may be used in a calibration process to detect the fly height of ABS 300. When power is applied to a heater (not shown in FIG. 3), the protrusion of the read/write head may grow until the protrusion touches the surface of the disk, at which point the protrusion detects the surface of the disk and the protrusion backs off. While the protrusion extends, air continues to circulate within the interior of the HDD due to the spinning of the disk(s). The circulating air causes pressure (i.e., the touchdown pressure) on the protrusion. If the touchdown pressure is too high, then the extendable protrusion does not interact enough with the disk, and the ability of the protrusion to properly detect the surface of the disk, and by extension correctly measure the current fly height, is degraded. On the other hand, if the touchdown pressure is too low, then the extendable protrusion interacts too much with the disk, which may damage the surface of the disk.

Additionally, use of hollow recess 350 tends to lower the efficiency of the extendable protrusion. The efficiency of the extendable protrusion refers to how fast the extendable protrusion will grow in response to the application of power to the heater. Thus, by lowering the efficiency of the extendable protrusion, the rate of growth of the extendable protrusion is reduced. Lowering the efficiency of the extendable protrusion requires a lower fly height of the ABS 300 to achieve best results.

It is observed that the undesirable effects on increasing touchdown pressure resulting from the use of hollow recess 330 may be offset by the use of slit feature 360 by certain embodiments. Slit feature 360 is a channel etched to expose layer 344. Thus, in an embodiment, slit feature 360 may not be as deep as hollow recess 350. As shown in FIG. 3, slit feature 360 may be positioned (a) equidistant from side 360 and side 362 and (b) in-between hollow recess 350 and transducer 330. Slit feature 360 may run substantially perpendicular to the direction of air flow across ABS 300.

The use of slit feature 360 yields the desirable advantage of lowering touchdown pressure on the extendable protrusion. Slit feature 360 is positioned in front of the extendable protrusion to divert air into the channel of slit feature 360 and to prevent the air channel of slit feature from pressurizing the air directly on top of the extendable protrusion. This reduces the touchdown pressure and increases the efficiency of the extendable protrusion.

In different embodiments, the size and the shape of slit feature 360 may differ, as long as wherein the physical dimensions of slit feature 360 achieve the objective of lowering an amount of pressure required for a protrusion of the head slider to detect a surface of the magnetic-recording disk. In a particular embodiment, slit feature 360 may have an etch depth between 0.14 microns and 0.2 microns.

Advantageously, use of slit feature 360 has no impact to the fly height of the read/write head when the read/write head experiences a change in altitude. Consequently, if hollow recess 350 is used in conjunction with slit feature 360, slit feature 360 compensates for the drawback of using hollow recess 350 while still achieving the advantages provided by hollow recess 350.

Further, use of slit feature 360 also tends to improve the efficiency of the extendable protrusion. As a result, use of slit feature 360 supports a higher fly height for the ABS 300 to achieve best results.

Therefore, embodiments of the invention, such as the embodiment depicted in FIG. 3, which employ both hollow recess 350 and slit feature 360 enjoy many benefits, such as improved altitude resistance, improved touchdown detection (the ability to measure the current fly height of ABS 300), improved efficiency of the extendable protrusion, and support for a higher fly height of the ABS 300.

Note that certain embodiments of the invention (not depicted in FIG. 3) may employ slit feature 360 without hollow recess 350.

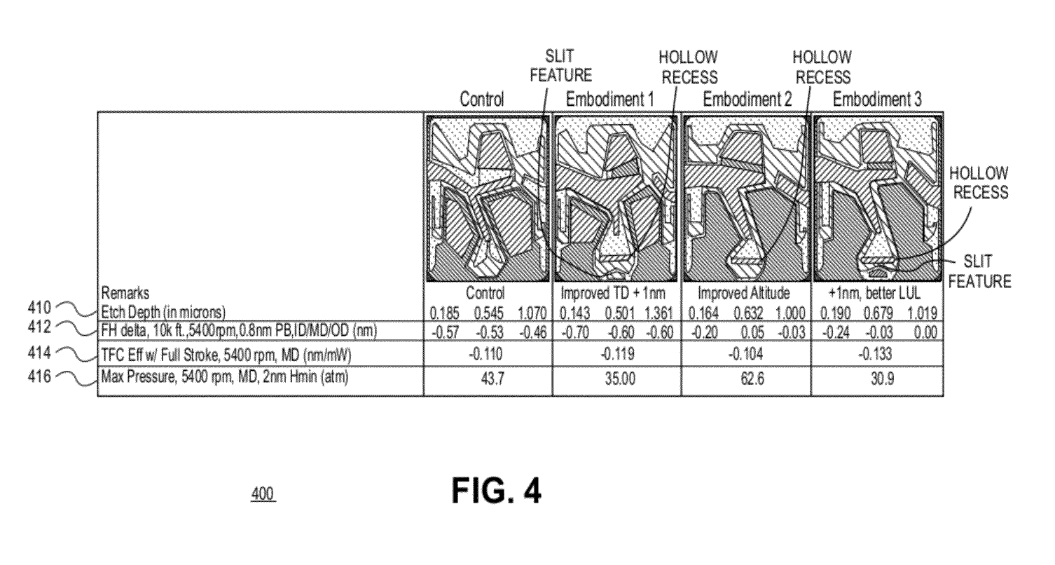

FIG. 4 is table 400 illustrating exemplary characteristics of the air bearing surface of a head according to embodiments of the invention. Row 412 of table 400 lists the etch depth layers 342, 344, and 346 for several embodiments. For example, in embodiment 3, layer 342 has an etch depth of 0.190 microns, layer 344 has an etch depth of 0.679 microns, and layer 346 has an etch depth of 1.019 microns. As evidenced by table 4, there may be variation to the physical dimensions of hollow recess 350 and slit feature 360 across various embodiments.

Row 412 illustrates the fly height change due to altitude change between sea level and 10 kft elevation at ID, MD and OD radii.

Row 414 illustrates the efficiency of the extendable protrusion for various embodiments. As evidenced by table 400, embodiments possessing slit feature 360 (embodiments 1 and 3) exhibit lowered touchdown pressure than those embodiments lacking slit feature 360 (control and embodiment 2).

Row 416 illustrates touchdown pressure for various embodiments. As evidenced by table 400, embodiments possessing slit feature 360 (embodiments 1 and 3) exhibit lowered touchdown pressure than those embodiments lacking slit feature 360 (control and embodiment 2).

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A hard-disk drive, comprising:
a head slider having an air bearing surface, wherein an electromagnetic transducer is disposed at an air outflow end of the air bearing surface;
a magnetic-recording disk rotatably mounted on a spindle;
a drive motor having a motor shaft attached to the spindle for rotating the magnetic-recording disk; and
a voice-coil motor configured to move the head slider to access portions of the magnetic-recording disk,
wherein the air bearing surface comprises a hollow recess prior to the electromagnetic transducer in a direction of air flow,
wherein the air bearing surface comprises a slit feature that is present between the electromagnetic transducer and the hollow recess, and
wherein a portion of a top layer of the air bearing surface exists between the hollow recess and the slit feature.

2. The hard-disk drive of claim 1, wherein the size and the shape of the hollow recess are designed to decrease a change in a fly height of the head slider in response to a change in altitude of the hard-disk drive.

3. The hard-disk drive of claim 1, wherein the physical dimensions of the slit feature are designed to lower an amount of pressure required for a protrusion of the head slider to detect a surface of the magnetic-recording disk.

4. The hard-disk drive of claim 1, wherein the slit feature has an etch depth between 0.14 microns and 0.2 microns.

5. The hard-disk drive of claim 1, wherein the hollow recess has an etch depth between 1.0 microns and 1.37 microns.

6. The hard-disk drive of claim 1, wherein the dimensions and placement of the hollow recess and the slit feature are designed to (a) decrease a change in a fly height of the head slider in response to a change in altitude of the hard-disk drive without (b) increasing an amount of pressure required for a protrusion of the head slider to detect a surface of the magnetic-recording disk.

7. The hard-disk drive of claim 1, wherein the slit feature runs substantially perpendicular to the direction of air flow.

8. The hard-disk drive of claim 1, wherein the hollow recess runs substantially perpendicular to the direction of air flow.

9. A head slider, comprising:
an air bearing surface; and
an electromagnetic transducer disposed at an air outflow end of the air bearing surface,
wherein the air bearing surface comprises a slit feature prior to the electromagnetic transducer in a direction of air flow, and wherein the physical dimensions of the slit feature are designed to lower an amount of pressure required for a protrusion of the head slider to detect a surface of the magnetic-recording disk,
wherein the slit feature is etched into a top layer of the air bearing surface.

10. The head slider of claim 8, wherein the air bearing surface further comprises a hollow recess prior to the slit feature in the direction of air flow.

11. The head slider of claim 9, wherein the size and the shape of the hollow recess are designed to decrease a change in a fly height of the head slider in response to a change in altitude of the hard-disk drive.

12. The head slider of claim 8, wherein the slit feature has an etch depth between 0.14 microns and 0.2 microns.

13. The head slider of claim 9, wherein the hollow recess has an etch depth between 1.0 microns and 1.37 microns.

14. The head slider of claim 9, wherein the dimensions and placement of the hollow recess and the slit feature are designed to (a) decrease a change in a fly height of the head slider in response to a change in altitude of the hard-disk drive without (b) increasing an amount of pressure required for a protrusion of the head slider to detect a surface of the magnetic-recording disk.

15. The head slider of claim 8, wherein the slit feature runs substantially perpendicular to the direction of air flow.

16. The head slider of claim 8, wherein the hollow recess runs substantially perpendicular to the direction of air flow.

17. A head slider, comprising:
an air bearing surface; and
an electromagnetic transducer disposed at an air outflow end of the air bearing surface,
wherein the air bearing surface comprises a slit feature that is present prior to the electromagnetic transducer in a direction of air flow, wherein the physical dimensions of the slit feature are designed to lower an amount of pressure required for a protrusion of the head slider to detect a surface of the magnetic-recording disk,
wherein the air bearing surface further comprises a hollow recess prior to the electromagnetic transducer in a direction of air flow, wherein the size and the shape of the hollow recess are designed to decrease a change in a fly height of the head slider in response to a change in altitude of the hard-disk drive, and
wherein a portion of a top layer of the air bearing surface exists between the hollow recess and the slit feature.

18. The head slider of claim 15, wherein the slit feature has an etch depth between 0.14 microns and 0.2 microns.

19. The head slider of claim 15, wherein the hollow recess has an etch depth between 1.0 microns and 1.37 microns.

20. The head slider of claim 15, wherein the dimensions and placement of the hollow recess and the slit feature are designed to (a) decrease a change in a fly height of the head slider in response to a change in altitude of the hard-disk drive without (b) increasing an amount of pressure required for a protrusion of the head slider to detect a surface of the magnetic-recording disk.

21. The head slider of claim 15, wherein the slit feature runs substantially perpendicular to the direction of air flow.

22. The head slider of claim 15, wherein the hollow recess runs substantially perpendicular to the direction of air flow.

23. The hard-disk drive of claim 1, wherein the slit feature runs substantially perpendicular to the direction of air flow, wherein the hollow recess runs substantially perpendicular to the direction of air flow, and wherein the hollow recess is etched deeper into the air bearing surface than the slit feature.

24. The head slider of claim 9, wherein the slit feature runs substantially perpendicular to the direction of air flow, wherein the hollow recess runs substantially perpendicular to the direction of air flow, and wherein the hollow recess is etched deeper into the air bearing surface than the slit feature.

25. The head slider of claim 15, wherein the slit feature runs substantially perpendicular to the direction of air flow, wherein the hollow recess runs substantially perpendicular to the direction of air flow, and wherein the hollow recess is etched deeper into the air bearing surface than the slit feature.
